(19) United States
(12) Patent Application Publication
(10) Pub. No.: US 2008/0072066 A1
(43) Pub. Date: Mar. 20, 2008

(54) METHOD AND APPARATUS FOR AUTHENTICATING APPLICATIONS TO SECURE SERVICES

(75) Inventors: Dean H. Vogler, Algonquin, IL (US); Ronald F. Buskey, Sleepy Hollow, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/465,964

(22) Filed: Aug. 21, 2006

(51) Int. Cl. G06F 12/14

(52) U.S. Cl. 713/187

(57) ABSTRACT

During a first time interval, an authentication system produces a fingerprint of a first application, encrypts it and stores the encrypted fingerprint in a memory. In second time interval the authentication system produces a fingerprint of a second application, and retrieves the encrypted fingerprint of the first application from the memory. The encrypted fingerprint of the first application is decrypted to recover the fingerprint of the first application. The second application is authenticated if the fingerprint of the first application is equal to the fingerprint of the second application. The fingerprint may include a hash value of the program of computer instructions of the application. The fingerprint of the first application may be encrypted using an embedded secret key of the authentication system.

### FIELD OF THE INVENTION

The present invention relates generally to the field of computer security. More particularly, the invention relates to the authentication of computer applications to secure services.

### BACKGROUND

Portable devices, such as cellular telephones, personal digital assistants, handheld computers and the like, may use security-based processors. Secure processors may utilize a secret key that is embedded in the processor. This embedded secret key is accessible by an internal operation on the processor and controlled by hardware or software on the processor or memory. For example, the embedded secret key may be stored in a protected, read only memory. This provides a root core of security, since it allows encryption and decryption operations to be controlled in a secure environment, and prevents access by any other user. The controlling hardware and/or software used to access the embedded secret key and perform cryptographic operations is referred to as a Secure Service in the sequel.

However a problem exists when an application (a software controlled process executed on the device) wishes to use encryption keys to access secure data. For example, when a banking application executing on the device wishes to protect sensitive customer data, such as credit card numbers and account information, the data must be encrypted. Typically, the banking application would request its own application key (i.e., one that is not used by any other application) that would then be used to encrypt the sensitive data. The application may ask the Secure Service to perform this service, in which case the Secure Service will generate a random application key, and then protect the application key with the embedded secret key. The encrypted application key can then be stored in a flash memory external to the secure processor. With this approach, no one can decrypt the application key except the Secure Service, since only the Secure Service can access the embedded secret key and the embedded secret key can never leave the secure memory on the processor. Thus, the bank application can achieve its goal by using the application key to encrypt its sensitive data. Later, when the bank application needs to access the sensitive data, it makes a request to the Secure Service to access the application key to enable the Secure Service to perform the decryption.

However, this approach has a weakness in that a rogue application, developed by a malicious programmer and executed on the device, can make an identical request to the Secure Service. The objective of the rogue application is to access the sensitive banking data. The rogue application doesn't need to know the actual value of the embedded secret key or the application key. The rogue application can make the same request to the Secure Service that the banking application did, and thus obtain access to the data. In this situation, there is nothing to differentiate the bank application's request from the rogue application's request.

One technique to avoid the above scenario is to require that an application presents a credential, such as an authenticating token, to the Secure Service to generate and access its keys. For example, a personal identification number (PIN) and/or password credential may be required for the Secure Service to validate an application's request to access keys. This raises the question of how the application stores and protects the PIN/password. One approach is to simply embed the PIN/password in the application code, perhaps by obfuscation. Another approach is to scramble the PIN/password and store it in flash memory. Applications that use locally created keys for encryption do not provide strong security since they store an unencrypted “root” key. It is relatively easy to reverse engineer where obfuscated data is stored.

Another approach is to require the user to remember the PIN/password for each application. This approach fails if a user forgets, or accidentally reveals, the PIN/password.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram of an exemplary electronic device, in accordance with certain embodiments of the invention.

FIG. 2 is a flow chart of a prior method of data storage.

FIG. 3 is a flow chart of a prior method of data retrieval.

FIG. 4 is a flow chart of a method of application key generation, in accordance with certain embodiments of the invention.

FIG. 5 is a flow chart of a method of data storage or retrieval, in accordance with certain embodiments of the invention.

FIG. 6 is a sequence chart of a method of application key generation, in accordance with certain embodiments of the invention.

FIG. 7 is a sequence chart of a method of data storage or retrieval, in accordance with certain embodiments of the invention.

### DETAILED DESCRIPTION

Before describing in detail embodiments that are in accordance with the present invention, it should be observed that the embodiments reside primarily in combinations of method steps and apparatus components related to authentication of an application to a Secure Service of a processor. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

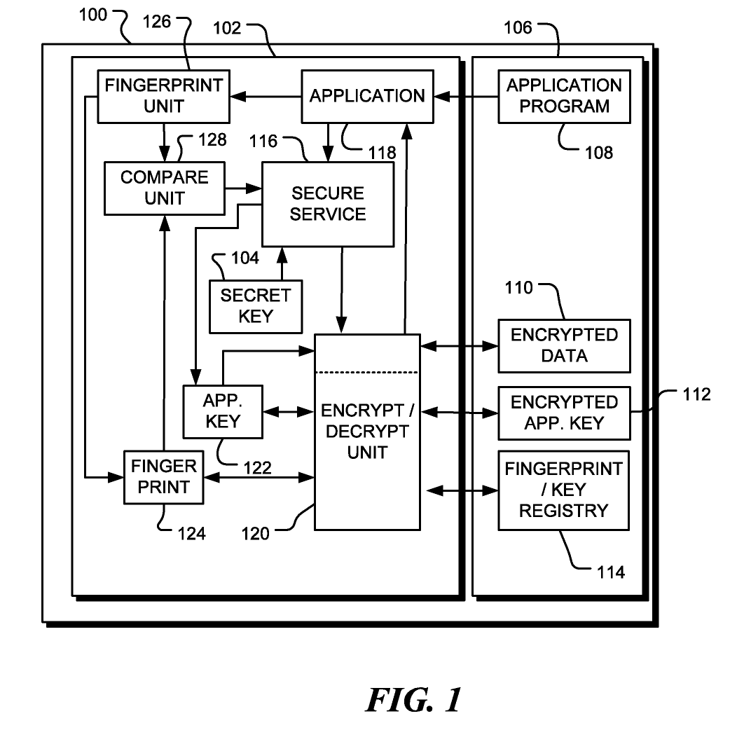

FIG. 1 is a diagram of an exemplary electronic device, in accordance with certain embodiments of the invention. The electronic device may be, for example, a portable device, such as a cellular telephone, personal digital assistants, handheld computer and the like. The electronic device uses an authentication system consistent with certain embodiments of the invention. The electronic device 100 includes a secure processor 102. Embedded within the processor is an embedded secret key 104. For example, the embedded secret key may be stored in a protected, read only memory. The secure processor 102 communicates with a memory 106. The memory 106 may be used to store, for example, one or more application programs 108, encrypted data 110, one or more encrypted application keys 112 and a registry 114. The registry 114 stores one or more encrypted fingerprints together with correspond application key identifiers. The memory may comprise internal memory, external memory or a combination thereof. If the registry is stored in external memory, the contents of the registry may be encrypted using the embedded secret key of the processor.

The processor 102 is operable to execute one or more processes such as a Secure Service 116 and the application 118. The term ‘application’ will be used in the sequel to mean both the program of computer instructions defining a process and the process itself. The secure service controls an encryption/decryption unit 120. The encryption/decryption unit 120 is operable to encrypt and decrypt values using the embedded secret key 104 or one or more application keys 122 stored in random access memory (RAM) in the processor. The application keys 122 are generated by the Secure Service. They are recovered from the encrypted application keys 112. A fingerprint 124 is also held in RAM. The fingerprint 124 may be generated by a fingerprint unit 126 or recovered from the encrypted fingerprints in the registry 114. The processor 102 also includes a compare unit 128 operable to compare the fingerprint computed by the fingerprint unit 126 with a decrypted fingerprint 124 stored in RAM.

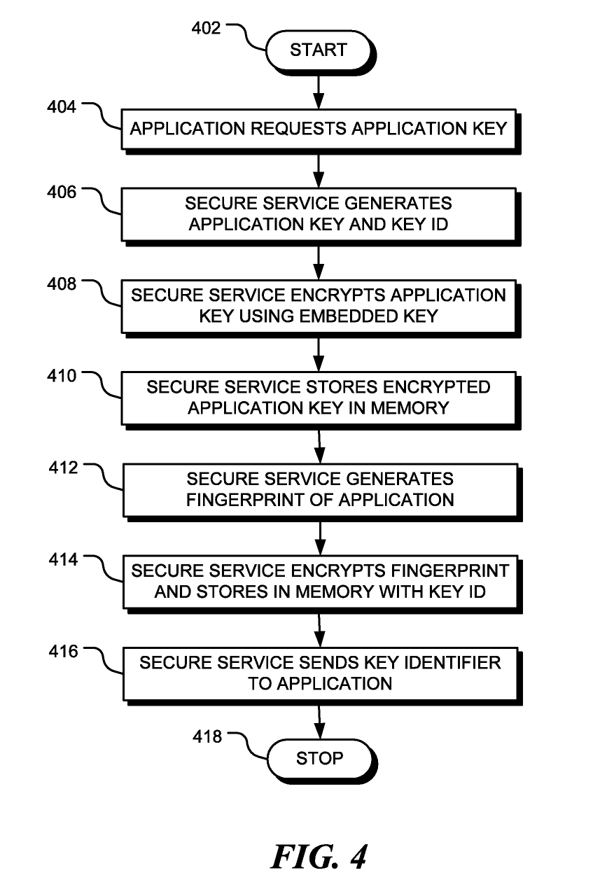

One function of the processor 102 is to authenticate the application 118 to the Secure Service 116. A further function of the processor 102 is to control access of the application 118 to the encrypted data 110. Operation of the electronic device is described below with reference to FIGS. 4-7.

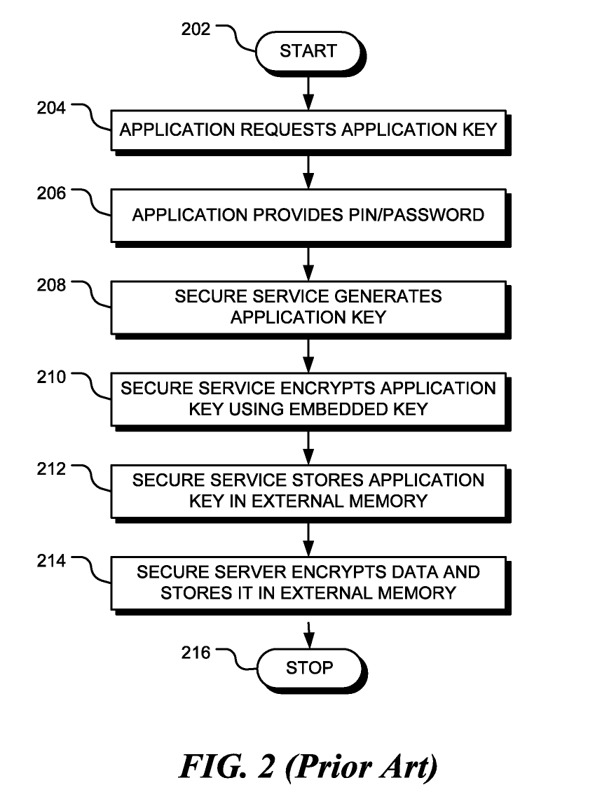

FIG. 2 is a flow chart of a prior method of data storage. Following start block 202 in FIG. 2, an application that wishes to store encrypted data requests, at block 204, that a Secure Service provides an application key. The application comprises a plurality of computer instructions that is executable on a process to perform a specified function. At block 206, the application provides a PIN/password to protect the application key. The element 206 is optional, since the PIN or password may be provided with the data request. At block 208, the Secure Service generates an application key. At block 210, the Secure Service encrypts the application key using the embedded secret key embedded in the secure processor. The encrypted application key is stored in external memory at block 212. At block 214, the Secure Service encrypts the data using the application key and stores the encrypted data in external memory. The process terminates at block 216.

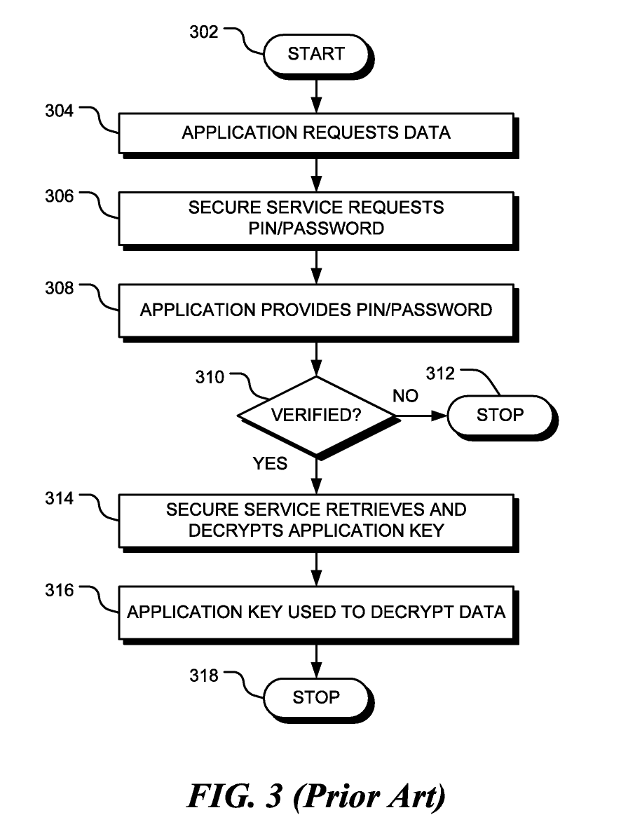

FIG. 3 is a flow chart of a prior method of data retrieval. Following start block 302 in FIG. 3, an application requests the Secure Service to retrieve encrypted data from the external memory. At block 306, the Secure Service requests a PIN or password from the application. At block 308 the application responds with a PIN or password. The element 306 is optional, since the PIN or password may be provided with the data request. At decision block 310 the Secure Serve determines if the PIN or password matches a corresponding stored value (that may be encrypted using the embedded secret key). If there is no match, as depicted by the negative branch from decision block 310, the process terminates at block 312 and the data is not retrieved. If there is a match, as depicted by the positive branch from decision block 310, the Secure Service retrieves and decrypts the application key at block 314 and the decrypted application key is used to decrypt the data at block 316. The process terminates at block 318. This approach does not provide strong security since it requires that the application store a PIN or password (or some root key if these are encrypted).

FIG. 4 is a flow chart of a method of application key generation, in accordance with certain embodiments of the invention. The method includes elements that prepare the Secure Service to authenticate an application at a later time. Following start block 402 in FIG. 4, an application that wishes to store or retrieve encrypted data requests, at block 404, that a Secure Service provides an application key. At block 406, the Secure Service generates an application key and a corresponding application key ID. At block 408, the Secure Service encrypts the application key using the embedded secret key embedded in the secure processor. The encrypted application key is stored in external memory at block 410. At block 412, the Secure Service generates a fingerprint of the application. This fingerprint may be generated, for example, by calculating a hash value of the application program. Optionally, the fingerprint may also depend upon a unique identifier of the secure processor, so that the fingerprint is unique to both the application and the device. At block 414 the fingerprint is encrypted using the embedded secret key of the processor and stored in memory, together with the application key ID. At block 416, the Secure Service provides an application key identifier to the application, so as to enable to application to indicate to the server which application key is to be used when a data store or retrieval is required at a later time. The Secure Service may maintain a registry of application key ID's and corresponding fingerprints. The process terminates at block 418.

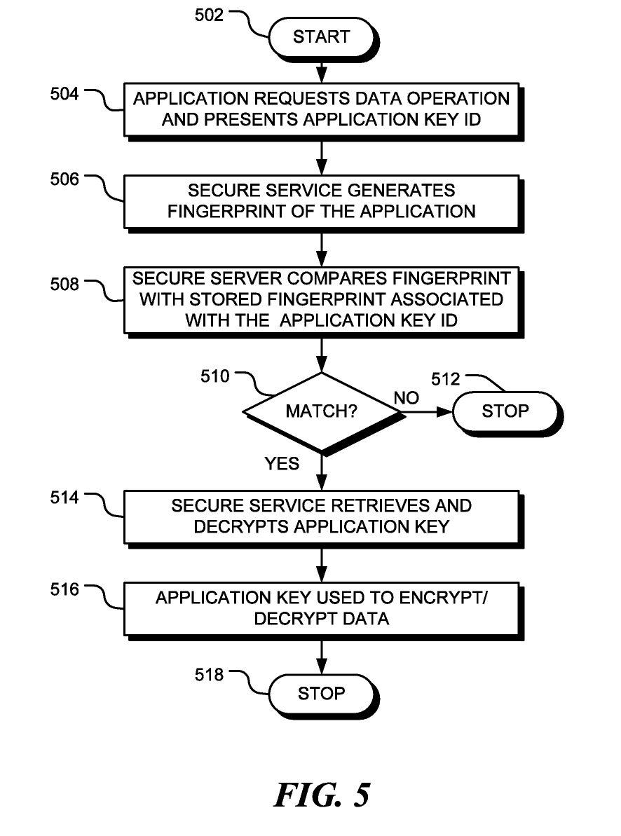

FIG. 5 is a flow chart of a method of data storage or retrieval, in accordance with certain embodiments of the invention. The method includes elements that enable a Secure Server to authenticate an application before data storage or retrieval is permitted. Following start block 502 in FIG. 5, an application requests, at block 504, the Secure Service to access the external memory for data retrieval or storage. The request may include an application key identifier corresponding to an application key generated previously. At block 506, the Secure Service generates a fingerprint of the application making the request. At block 508, the Secure Service decrypts the fingerprint associated with the provided application key identifier and compares the decrypted fingerprint with the calculated fingerprint of the application making the request. At decision block 510 the Secure Service determines if the calculated fingerprint matches the stored fingerprint. If there is no match, as depicted by the negative branch from decision block 510, the process terminates at block 512 and the data is not retrieved. If there is a match, as depicted by the positive branch from decision block 510, the Secure Service retrieves and decrypts the application key at block 514 and the application key is used to perform the requested data operation at block 516. For example the encrypted data could be retrieved, decrypted and provided to the application, or data provided by the application could be encrypted and stored in the external memory. The process terminates at block 518. This approach provides strong security, since it does not require that the application store a PIN, password, or other root key be unencrypted. A rogue application will have a different fingerprint compared to the legitimate application and so will be unable to access the data. The application keys and the fingerprints are encrypted using the embedded secret key and so cannot be accessed except by the Secure Service.

In this approach, the PIN/password is replaced by a fingerprint of the application, which is an unforgeable, non-duplicated, identity. Thus, the application's own identity forms the authentication credential.

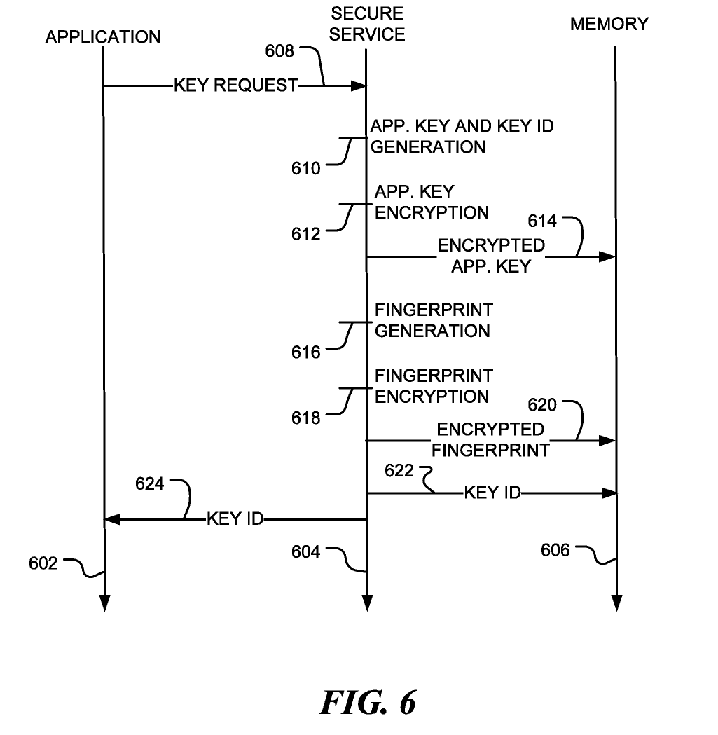

FIG. 6 is a sequence chart of a method of application key generation, in accordance with certain embodiments of the invention. FIG. 6 shows timeline 602 for an application (the storing application) executing on a processor of a device, timeline 604 for a Secure Service executing on the processor and timeline 606 of an external memory. The process of data storage begins when the application requests an encryption key from the Secure Service at 608. At 610 the Secure Service generates the application key and a corresponding application key ID and at 612 it encrypts the application key using the embedded secret key of the processor. At 614 the encrypted application key is stored in the external memory. At 616, the Secure Service generates a fingerprint of the application making the key request. The fingerprint may be, for example, a hash value of the program of computer instructions that define the application. The fingerprint is encrypted at time 618 using the embedded secret key of the processor. At time 620 the Secure Service stores the encrypted fingerprint in the external memory and at time 622, it stores the application key ID in the memory. At time 624 the Secure Service provides the application key identifier to the application to enable the application to identify the generated application key at a later time. The memory may contain a registry or database of application key IDs and associated fingerprints.

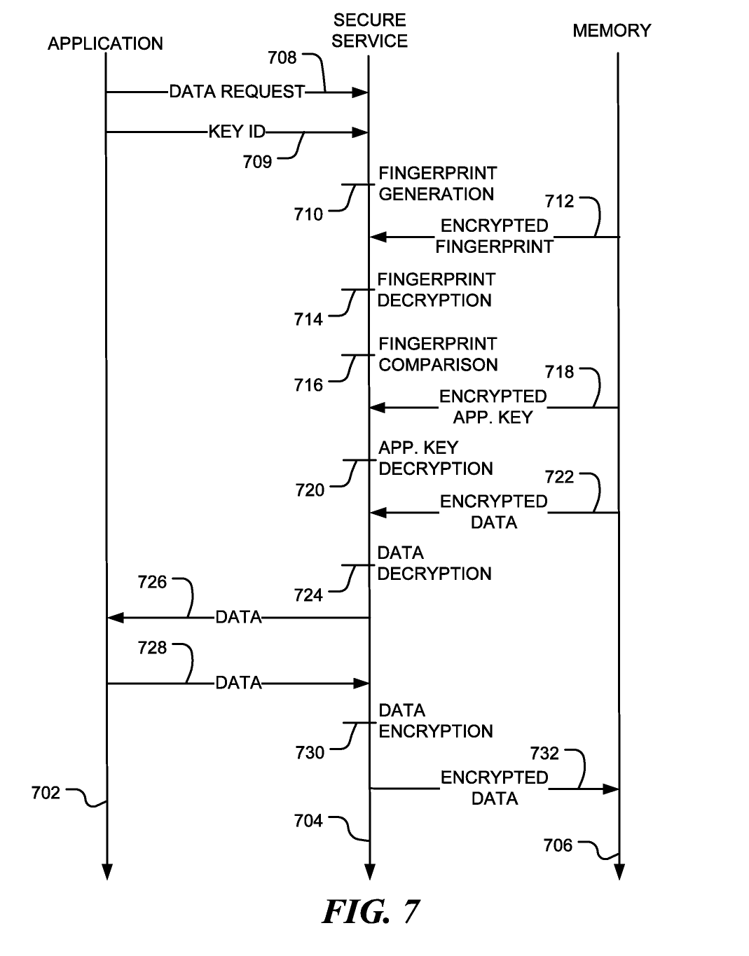

FIG. 7 is a sequence chart of a method of data storage or retrieval, in accordance with certain embodiments of the invention. FIG. 7 shows timeline 702 for an application executing on a processor of a device, timeline 704 for a Secure Service executing on the processor and timeline 706 of an external memory. The process of data storage or retrieval begins when the application requests a data operation from the Secure Service at 708 and provides the application key ID at 709. The application key ID may be included in the request. At 710, the Secure Service generates a fingerprint of the application making the data request. At 712 the Secure Service retrieves the encrypted fingerprint of the application that stored the data (the storing application), and at 714 it decrypts the encrypted fingerprint using the embedded secret key of the processor. At 716 the fingerprint of the storing application is compared with the fingerprint of the retrieving application. The data request is denied if the fingerprints do not match. If the fingerprints match, the encrypted application key corresponding to the application key identifier is retrieved from the external memory at 718 and decrypted at 720 using the embedded secret key of the processor. The application may now retrieve or store data. For example, at 722 the encrypted data is retrieved from the memory and is decrypted using the application key at 724. Finally, at 726, the decrypted data is made available to the retrieving application. Alternatively, the application may provide data to be store at 728. The Secure Service encrypts the data at 730 using the decrypted application key and the encrypted data is stored in the external memory at 732.

In one embodiment of the invention, the Secure Service manages a registry of application key ID's and encrypted fingerprints, and the registry itself is protected by the embedded secret key. The Secure Service can take requests to add application keys to the registry, delete application keys from the registry, and optionally re-map application keys in the registry. The latter may be required in cases in which an application (such as the banking application) is updated, and the updated application itself has a new fingerprint as a result.

It will be apparent to those of ordinary skill in the art that the method described above may be modified for uses other that the control of access to protected data. For example, the method may be used to control access to other resources such as processing resources, network resources etc.

The methods and computational units (such as the fingerprint unit, encryption/decryption unit, comparison unit) in the foregoing description may be implemented on programmed processor executing instructions stored in a computer readable medium. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for an electronic device to protect stored data, the method comprising:
computing a fingerprint of an application requesting access to the stored data;
comparing the fingerprint of the requesting application to the fingerprint of a storing application that generated the stored data; and
allowing the requesting application access to the stored data if the fingerprint of the requesting application matches the fingerprint of storing application.

2. A method in accordance with claim 1, wherein the electronic device comprises a memory and a processor with an embedded secret key, the method further comprising:
calculating the fingerprint of the storing application;
encrypting the fingerprint of the storing application using the embedded secret key of the processor; and
storing the encrypted fingerprint of the storing application in the memory, wherein comparing the fingerprint of the requesting application to the fingerprint of a storing application that generated the stored data comprises decrypting, with the embedded secret key of the processor, an encrypted fingerprint of the storing application.

3. A method in accordance with claim 1, wherein the electronic device comprises a memory and a processor with an embedded secret key, the method further comprising:
generating an application key;
encrypting the application data using the application key to produce the stored data;
encrypting the application key using the embedded secret key of the processor; and
storing the encrypted application key in the memory.

4. A method in accordance with claim 3, wherein allowing the requesting application access to the stored data comprises:
retrieving the encrypted application key from the memory;
decrypting the encrypted application key to recover the application key; and
decrypting the stored data using the application key.

5. A method in accordance with claim 3, further comprising:
receiving an application key identifier from the requesting application; and
selecting the fingerprint of the storing application from a registry in the memory in accordance with the application key identifier,
wherein the registry contains fingerprints and corresponding application key identifiers.

6. A method in accordance with claim 1, wherein computing a fingerprint of an application requesting access to the stored data comprises calculating a hash value of the application.

7. A method in accordance with claim 6, wherein computing a fingerprint of an application requesting access to the stored data further comprises combining the hash value of the application with an identifier of the electronic device.

8. A computer readable medium containing program instructions that, when executed on a processor, perform the method of claim 1.

9. An electronic device operable to perform the method of claim 1.

10. A method for authenticating an application to a Secure Service of a processor, the method comprising:
in a first time interval:
producing a fingerprint of a first application;
encrypting the fingerprint of the first application; and
storing the encrypted fingerprint of the first application in a memory; and
in a second time interval:
producing a fingerprint of a second application;
retrieving the encrypted fingerprint of the first application from the memory;
decrypting the encrypted fingerprint of the first application to recover the fingerprint of a first application; and
authenticating the second application if the fingerprint of the first application is equal to the fingerprint of the second application.

11. A method in accordance with claim 10, wherein the first application comprises a program of computer instructions and wherein producing a fingerprint of a first application comprises computing a hash value of the program of computer instructions.

12. A method in accordance with claim 11, wherein producing a fingerprint of the first application further comprises combining the hash value with an identifier of the processor.

13. A method in accordance with claim 10, wherein encrypting the fingerprint of the first application comprises encrypting the fingerprint of the first application using an embedded secret key of the processor.

14. A computer readable medium containing program instructions that, when executed on a processor, perform the method of claim 10.

15. An electronic device operable to perform the method of claim 10.

16. An authentication system, comprising:
a computer readable medium operable to store a first application comprising a first program of computer instructions and a second application comprising a second program of computer instructions;
a fingerprint unit operable to produce a fingerprint of the first application in a first time interval and a fingerprint of the second application in a second time interval, subsequent to the first time interval;
a memory operable to store the fingerprint of the first application; and
a comparison unit operable to compare the fingerprint of the first application and the fingerprint of the second application and produce an output indicative of whether the fingerprint of the first application is equal to the fingerprint of the second application,
wherein the second application is authenticated if the fingerprint of the first application is equal to the fingerprint of the second application.

17. A system in accordance with claim 16, further comprising:
an encryption unit operable to encrypt the fingerprint of the first application in the first time interval; and
a decryption unit operable to decrypt the fingerprint of the first application in the second time interval;
wherein the memory is operable to store the encrypted fingerprint of the first application.

18. A system in accordance with claim 16, wherein the fingerprint of the first application comprises a hash value of the first program of computer instructions and the fingerprint of the second application comprises a hash value of the second program of computer instructions.

19. A system in accordance with claim 16, wherein the fingerprint of the first application further comprises an identifier of the authentication system.

20. A system in accordance with claim 16, further comprising:
an embedded secret key; and
an encryption unit operable to encrypt the fingerprint of the first application using the embedded secret key.

21. A system in accordance with claim 20, wherein the encryption unit is further operable to encrypt an application key in the first time interval using the embedded secret key, and wherein the memory is further operable to store the encrypted application key.

22. A system in accordance with claim 21, wherein the memory is further operable to store encrypted data of the first application, encrypted using the application key, and wherein the second application is allowed to access the data if the fingerprint of the first application is equal to the fingerprint of the second application.

23. A system in accordance with claim 20, wherein the memory is further operable to store an application key identifier corresponding to the fingerprint of the first application.
